(19) United States
(12) Patent Application Publication
(10) Pub. No.: US 2013/0266415 A1
(43) Pub. Date: Oct. 10, 2013

(54) Vehicle Supporting Device

(71) Applicants: Michael Adam Czartoryski, Poznan (PL); Mads Grothenberg, Solrod Strand (DK)

(72) Inventors: Michael Adam Czartoryski, Poznan (PL); Mads Grothenberg, Solrod Strand (DK)

(21) Appl. No.: 13/823,411

(22) PCT Filed: Sep. 23, 2011
(86) PCT No.: PCT/IB11/54204

§ 371 Date: Jun. 17, 2013

(30) Foreign Application Priority Data
Sep. 24, 2010 (EP) 10179488.1

(51) Int. Cl. B66F 7/28

(52) U.S. Cl. CPC B66F 7/28
USPC 414/800; 248/346.01

(57) ABSTRACT

A vehicle supporting device (1) for a vehicle (V) comprising a carrier structure (2) and support members (3) extending from the carrier structure (2) and serving to support a vehicle by a pair of its wheels (W), said carrier structure (2) comprising a system of attachment points (6) for the support members (3) and provided on longitudinal surfaces (4) of the carrier (2), said members (3) protruding laterally to support said wheel (W), when supported, wherein the supporting device (1) further comprises a fork opening (5) configured to connect to a standard forklift (M), and wherein for each wheel (W) a set of said support members (3) are connected to selected ones of said attachment points (6) to provide a suitable mutual distance and height of said members (3). The invention further pertains to a method of using said vehicle supporting device.

### TECHNICAL FIELD

The present invention relates to a vehicle supporting device and a method to lift and maneuver a vehicle, when the vehicle needs to be moved within a location e.g. a garage for repairs.

### BACKGROUND ART

Salvage of cars is known to be performed by means of large trucks with a heavy trailing device to salvage a damaged or defect car and bring it to a garage for repairs, while the car is rolling on a pair of its own rear wheels or front wheels, the other pair of wheels being supported by the trailing device.

In a car repair shop or garage, need may arise to move a car from one point to another point within the location using simpler equipment.

EP 0 405 230 B1 describes a lifting device for elevating and maneuvering vehicles before repair work is initiated.

The known lifting device comprises a carrier with four parallel support rails extending laterally from the carrier to support wheels mounted on either a front axle or a rear axle and to bring a vehicle to a suitable position in a garage.

A first coaxial set of support rails are permanently fixed to the carrier in their extended position and a second set of coaxial support rails can be extended to preferably same width as the first set, when the front or rear wheels abut the first set of support rails from one direction, whereby the second set of coaxial support rails are hydraulically drawn towards the same wheels from an opposite direction reducing a distance between the two sets of rails to become shorter than a wheel or tire diameter, before raising an end of a vehicle.

The known lifting device is teaching use of hydraulic cylinders to adjust said distance between support rails, and hydraulic cylinders to laterally extend/withdraw the second set of support rails, which cylinders add to the complexity and price of such device.

In FR 2 340 837 is disclosed a transport device for road transport of cars. The disclosed transport device is configured to be towed by a vehicle. The transport device is rather large and is both wider and higher than a normal sedan. The transport device is adapted to carry the full weight of the car to be transported free from the ground. In essence the transport device is a transport trailer. It is furthermore equipped with supporting members for supporting the wheels of the car to be transported. These supporting members are attached at selected attachment points in a frame structure of the transport device.

Furthermore, U.S. Pat. No. 5,988,974 discloses a lifting and towing apparatus for transporting cars.

### SUMMARY OF THE INVENTION

It is the object of the present invention to design a less complex and affordable supporting device which all garages could afford to buy, and which requires nothing more than a stacker or forklift normally found in garages, to raise and move a vehicle around in the location, manually or driven by an electromotor.

A further object of the invention is to overcome problems with vehicles, whereof the wheels to be raised are damaged or punctured due to collision, whereby wheels are no longer in coaxial alignment and require different support in the two sides of the vehicle.

This and further objects are fulfilled by a vehicle supporting device for a vehicle comprising a carrier structure and support members extending from the carrier structure and serving to support a vehicle by a pair of its wheels. Said carrier structure comprises a system of attachment points for the support members and provided on longitudinal surfaces of the carrier, said members protruding laterally to support said wheel, when supported, wherein the supporting device further comprises a fork opening configured to connect to a standard stacker or standard forklift, and wherein for each wheel a set of said support members are connected to selected ones of said attachment points to provide a suitable mutual distance and height of said members. The attachment points can be distributed horizontally and vertically in order to obtain said distance and height of support members depending on the nature of possible damage to a wheel.

Hereby is achieved a more flexible adjustment, especially of the height of the wheels when supported, for example in order to provide coaxial alignment of the wheels even when one of them is punctured or otherwise damaged, thereby minimizing stress on other parts of said vehicle, and at the same time facilitating movement of a vehicle by a standard forklift. Hence, a small affordable supporting device is provided, which requires nothing more than a stacker or forklift to raise and move a vehicle around in a location such as a garage, and which at the same time provides the possibility of supporting the wheels at different heights in order to overcome the stress and tension problems in vehicles, where the wheels to be raised are damaged or punctured.

In a preferred embodiment of the invention, at least one member of a set of support members has a cranked form like a crank handle, and the distance between wheel contacting surfaces on said support members can be made shorter than the outer diameter of a tire of a wheel, depending on the attachment points or receiving openings used and the angular positioning of the support members.

In a further embodiment of the invention, receiving openings are formed as at least one longitudinal slit in one of said longitudinal surfaces, wherein said slit may have notches to secure the position and avoid sliding of support members in the longitudinal direction of said slit. This feature makes it easy to insert support members in the slit, sliding them to abutment with the tires, and letting them engage in the adjacent notches.

Each support member is provided with a latching element preventing said member from moving out of engagement with a respective attachment point or opening, when in use. Said latching element is protruding from the support member such that in one angular position, the support member can engage with said attachment points or openings, and in another angular position the support member is latched. Consequently, the latching element prevents the support member from sliding out of the carrier structure by turning the support member to the in-use position.

The support member according to the invention has a round, oval, square or multi-facetted cross section and an inner end of the support member is hooked into or over an edge of the carrier structure at the attachment points. As an alternative to inserting support members into receiving openings, usually in the side surface of the carrier structure, said members could be attached by clamping over and around or sticking under an edge of the carrier.

In order to improve support of a wheel, the support member could have an outer end covered by a support pad, and said pad may be formed as a spade.

In yet another advantageous embodiment of the invention, a set of support members supporting one wheel has a locking device in the form of any type of chain, wire or a fish plate capable of maintaining a mutual distance of the support members not to be exceeded when lifted.

In a preferred embodiment the carrier structure is connected to a supporting frame via a rotary joint, wherein the supporting frame is so arranged relative to the carrier structure, that the carrier structure is rotatable relative to the supporting frame. Hereby the rotary joint between the carrier structure and the supporting frame provides increased maneuverability during use, because it will in essence act as the rotary joint of a trailer of a truck.

Preferably, the rotary joint is connected to a top part of the supporting frame. The supporting frame also further comprises two sidewalls extending from the top part, wherein the sidewalls are so arranged relative to each other that they are able to accommodate the forks of a standard stacker or a standard forklift between them. Hereby the sidewalls will act as guides for the forks of the stacker or forklift, and thereby ensure correct positioning of them during use of the supporting device.

The invention also comprises a method of lifting and maneuvering a vehicle in a garage, wherein a supporting device comprising a carrier structure is positioned under a vehicle, then for each wheel of a front or rear axle of the vehicle a set of supporting members are attached to attachment points of a surface of said structure and protrudes laterally therefrom, said members supporting a tire on said wheel from below, the wheel contacting surfaces of the support members allowing a shorter mutual distance than the outer diameter of said tire, and said distance is secured by a locking device interlocking the support members, and finally a maneuvering device, e.g. a stacker or a forklift, is brought into operational engagement with connection means such as fork openings in the carrier structure in order for a vehicle resting on the supporting device to be lifted and maneuvered.

The method according to the invention preferably comprises a step, wherein the support members and/or attachment points are chosen to adapt properly to a height and distance defined by an adjacent tire/wheel on a vehicle to be moved to a new place in the location.

The supporting device according to the invention is preferably used with the method according to the invention.

### BRIEF DESCRIPTION OF THE DRAWINGS

A further understanding of the nature and advantages of the present invention may be realized by reference to the remaining portions of the specification and the drawings. In the following, preferred embodiments of the invention are explained in more detail with reference to the drawings, wherein

FIG. 1 is a general view of a vehicle being lifted and maneuvered by means of a vehicle supporting device according to the invention and a standard maneuvering device,

FIG. 2 is a schematic diagram of a first embodiment of a supporting device according to the invention,

FIG. 3 is a partial view of one side of a carrier structure with attachment points in a vertical side surface,

FIGS. 4A-C show several embodiments of a support member according to the invention,

FIG. 5A shows a cross sectional view of the use of a support member according to a second embodiment in FIG. 4A,

FIG. 5B shows the use of a support member according to a third embodiment in FIG. 4B,

FIG. 5C shows the use of a support member according to a fourth embodiment in FIG. 4C,

FIG. 6 shows a semi-transparent top view of an embodiment of a supporting device, and

FIG. 7 shows a cross sectional side view of the embodiment of the supporting device 1 illustrated in FIG. 6.

### DETAILED DESCRIPTION OF PREFERRED EMBODIMENTS

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout. Like elements will, thus, not be described in detail with respect to the description of each figure.

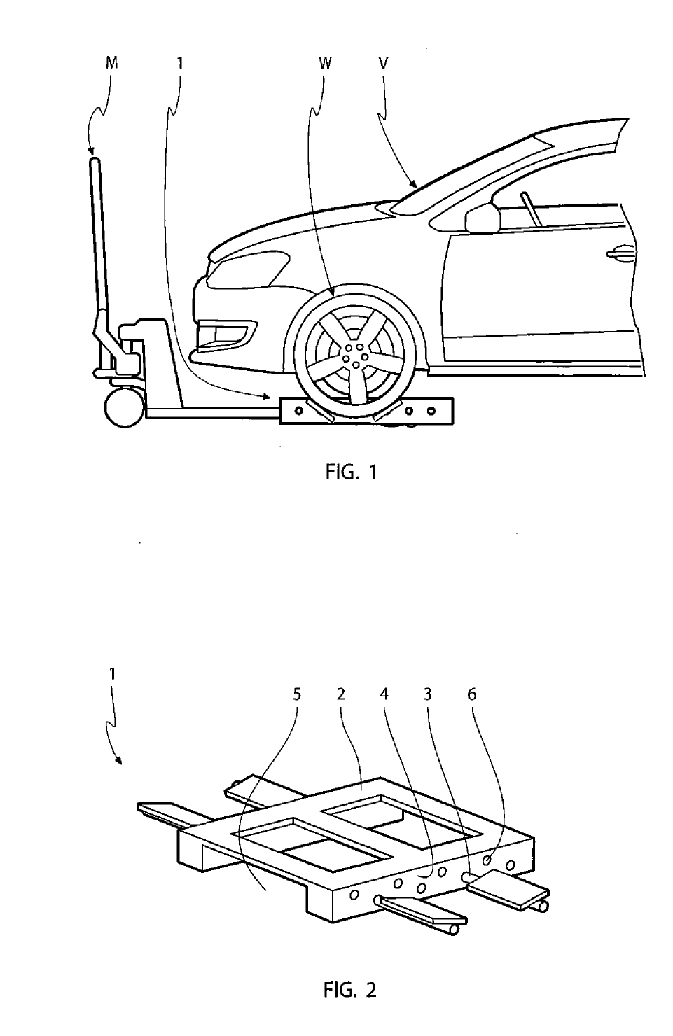

In one preferred embodiment of the invention shown in FIGS. 1 and 2, a supporting device 1 for a vehicle V comprises a carrier structure 2 and wheel supporting members 3 extending from surfaces 4 of the carrier structure 2, when in use, and serving to support a vehicle V by its front wheels W, as shown, or by its rear wheels. Furthermore, the carrier structure 2 comprises a fork opening 5 adapted to receive forks of a stacker or forklift M, the forklift M being able to lift and then maneuver the supporting device 1 supporting the front wheels W of a vehicle V, until a suitable place is found for the vehicle V in the location.

The carrier structure 2 can be configured e.g. in a rectangular or a U-shaped form as seen from above, and at the side surfaces 4 of the carrier 2 laterally oriented receiving openings 6 for support members 3 are provided along said side surfaces of the carrier 2. The support members 3 are insertable into said openings 6 to a suitable depth and are retained therein for the duration of bringing a vehicle to its destination point.

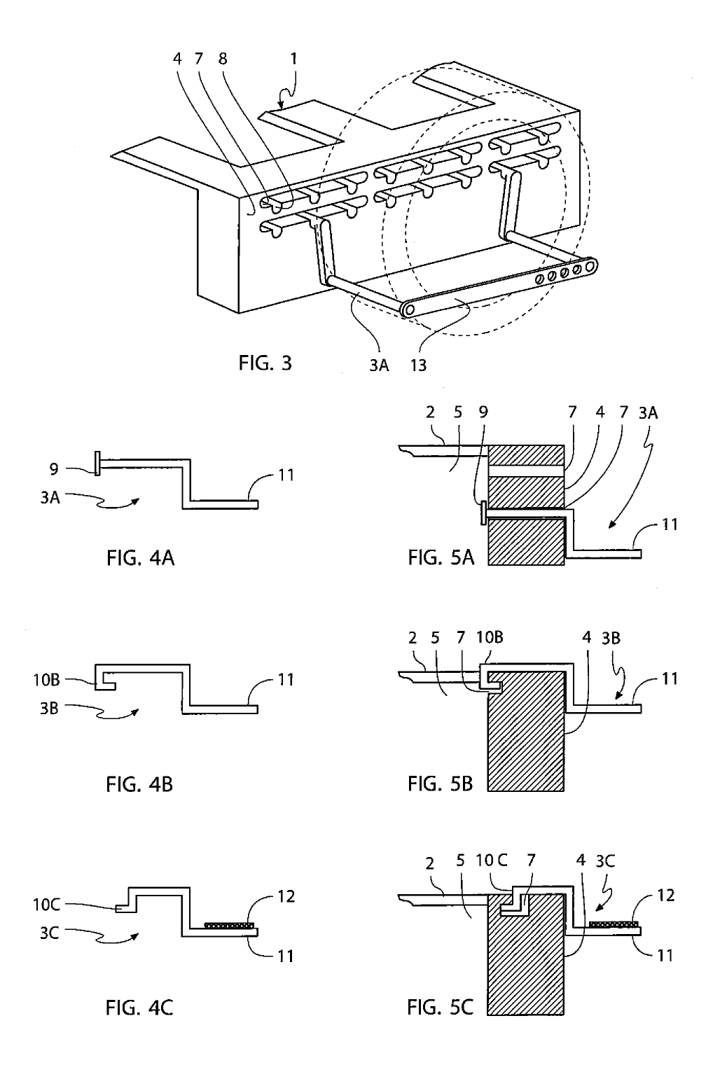

In an advantageous embodiment of the carrier 2 shown in FIG. 3, the receiving openings, rather than being separate openings, are formed by a longitudinal slit 7, wherein a support member 3 can be received and slide sideways until it is allowed to engage in a suitable notch 8. In this manner, two support members 3 support a tire from opposite directions of the slit 7. Any number of slits 7 and/or separate openings 6 is within the scope of the invention and will allow for different heights of support from one side to the other side of a vehicle.

In order to prevent support members 3 from accidentally shifting out of the carrier 2, each member 3 is provided with a stop or latching element 9 (visible in FIGS. 4A and 5A) at the inner end of a support member 3A, wherein said member 3A can freely be inserted into the carrier, and then said element 9 is brought in active position by rotating said member 3A to a position, wherein it is not allowed to pass freely out of the carrier 2. Depending on the cross section of the support member 3A and the shape of a corresponding opening 6 or slit 7, said member 3A can be fixed in a required angular position relative to a tire to be supported (see. FIGS. 2 and 3).

In another embodiment, the support member has a cranked form like a crank handle 3A, allowing easier fitting of the support members relative to a tire, wherein a set of support members 3 can be restricted to a maximum mutual distance by means of a fish plate or locking device 13 restricting the support surfaces of said members 3A to keep a mutual distance smaller than the diameter of a tire to be supported.

Referring now also to FIGS. 4B, 5B and 4C, 5C showing variations 3B, 3C of the cranked support member 3A, the inner end 10B is configured such that it shall be clamped around an edge of a carrier 2, or the end 100 can be positioned over the edge of the carrier 2 and engage under a further edge or overhang thereof.

In FIG. 5C, the support surface on the outer end 11 of a support member 3C is further covered by a support pad 12 comprising a resilient material or a friction layer, or formed as a spade to enlarge the support surface.

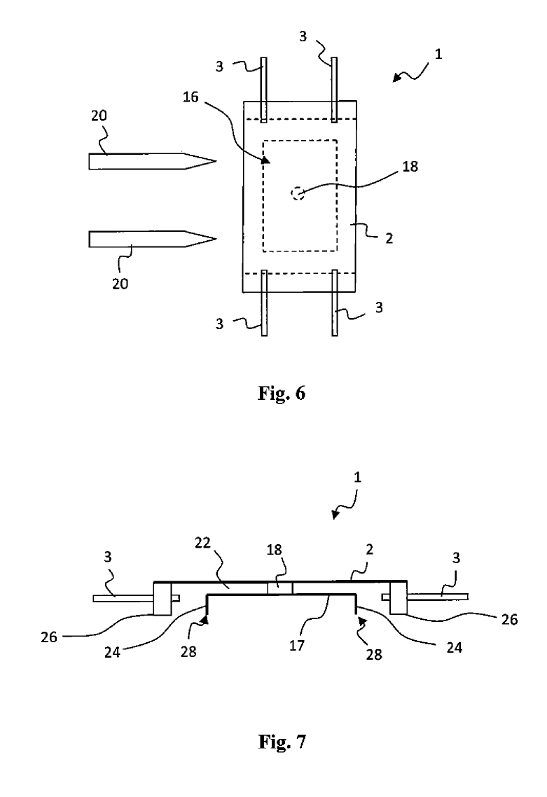

FIG. 6 shows a semi-transparent top view of another embodiment of a supporting device 1, wherein the carrier structure 2 is connected to a supporting frame 16 as indicated by the dashed lines. The carrier structure 2 is connected to a supporting frame 16 via a rotary joint 18. The supporting frame 16 is so arranged relative to the carrier structure 2, that the carrier structure 2 is rotatable relative to the supporting frame 16. By providing a supporting frame 16 relative to which the carrier structure 2 can rotate, an increased maneuverability is achieved. This increased maneuverability is especially important if the vehicle needs to be maneuvered in a small garage with limited space, because there will not always be enough room for turning the carrier structure in to its intended use position with the front (or back) wheels of a car on it. Also illustrated are the forks 20 of a standard forklift or a standard stacker M, which is used to move the vehicle. In the illustrated embodiment the supporting frame 16 has a rectangular form, but other shapes are also possible, for example cross formed frame(s).

FIG. 7 shows a cross sectional side view of the embodiment of the supporting device 1 illustrated in FIG. 6. As illustrated the supporting frame 16 is so arranged relative to the carrier structure 2 that a gap 22 is formed between them. This gap 22 between the supporting frame 16 and the carrier structure 2 allows the carrier structure to rotate freely (i.e. without friction) relative to the supporting frame 16 during use. The sidewalls 24 of the support frame 16 extend downwardly from the top part 17 of the supporting frame 16. Preferably, the ends 28 are substantially flush with the bottom part 26 of the carrier structure 2, so that both the ends 28 of the sidewalls 24 of the supporting frame and the bottom part of the carrier structure 2 touches the ground, when the supporting device 1 is placed in its intended use position on the ground. The ends 28 of the sidewalls 24 may be provided with a coating made from for example rubber or other suitable material in order to provide stability of the supporting device 1, when it is placed on the ground in its intended use position. The ground could for example be the floor of a garage. The sidewalls 24 are placed at a sufficiently large distance from each other that the forks 20 of a standard stacker or a standard forklift M is able to fit between them. Hereby they also will act as a guide for the forks 20 of the standard stacker or standard forklift M during insertion of the forks 20 into the supporting device 1.

### LIST OF REFERENCE NUMBERS

In the following is given a list of reference numbers that are used in the detailed description of the invention.
V vehicle,
W wheels of the vehicle,
M standard stacker or standard forklift,
1 supporting device,
2 carrier structure,
3 wheel supporting means,
3A, 3B, 3C variants of support members,
4 surface of carrier structure,
5 fork opening,
6 receiving openings for the wheel supporting members,
7 slit for the wheel supporting members,
8 notch,
9 stop or latching element,
10B,10C inner end of the wheel supporting members 3B, 3C,
11 outer end of wheel supporting member,
12 support pad,
13 fish plate or locking device,
16 supporting frame,
17 top part of supporting frame,
18 rotary joint,
20 forks of a forklift,
22 gap between the supporting frame and the carrier structure,
24 sidewalls of supporting frame,
26 bottom part of the carrier structure, and
28 ends of the sidewalls of the supporting frame.

1. Supporting device for a vehicle comprising a carrier structure and support members extending from the carrier structure and serving to support a vehicle by a pair of its wheels, said carrier structure comprising a system of attachment points (6) for the support members and provided on longitudinal surfaces of the carrier, said members protruding laterally to support said wheel, when supported, characterized in that the supporting device further comprises a fork opening configured to connect to a standard stacker or a standard forklift, and wherein for each wheel a set of said support members are connected to selected ones of said attachment points to provide a suitable mutual distance and height of said members.

2. Supporting device according to claim 1, wherein at least one of a set of support members has a cranked form like a crank handle, and wherein the distance between wheel contacting surfaces on said support members can be made shorter than the outer diameter of a tire on a wheel, depending on the attachment points or receiving openings used and rotation of the support members.

3. Supporting device according to claim 2, wherein said receiving openings are formed as at least one longitudinal slit in one of said longitudinal surfaces, wherein said slit may have notches to secure the position and prevent sliding of support members in the longitudinal direction of said slit.

4. Supporting device according to claim 1, wherein each support member is provided with a latching element preventing said member from accidentally moving out of engagement with a corresponding attachment point or opening, when in use.

5. Supporting device according to claim 4, wherein said latching element is protruding from the support member such that in one angular position the support member can engage with said attachment points or openings, and in another angular position the support member is latched.

6. Supporting device according to claim 1, wherein the support member is formed with a round, oval, square or multi-facetted cross section and an inner end of the support member is hooked into or over an edge of the carrier structure at the attachment opening, and wherein the attachment openings are configured to match the cross section of the support member.

7. Supporting device according to claim 1, wherein each support member has an outer end with a support surface covered by a support pad.

8. Supporting device according to claim 7, wherein the support member and the support pad is formed as a spade.

9. Supporting device according to claim 1, wherein said set of support members supporting one wheel has a locking device in the form of any type of chain, wire or a fish plate capable of maintaining a mutual distance of the support members not to be exceeded when lifted.

10. Supporting device according to claim 1, wherein the carrier structure is connected to a supporting frame via a rotary joint, wherein the supporting frame is so arranged relative to the carrier structure, that the carrier structure is rotatable relative to the supporting frame.

11. Supporting device according to claim 10, wherein the rotary joint is connected to a top part of the supporting frame and wherein the supporting frame further comprises two sidewalls extending from the top part and so arranged relative to each other that they are able to accommodate the forks of a standard stacker or a standard forklift (M) between them.

12. Method of lifting and maneuvering a vehicle in a garage, wherein a supporting device comprising a carrier structure is positioned under a vehicle, then for each wheel of a front or rear axle of the vehicle a set of supporting members are attached to suitable attachment points of a surface of said structure and protrudes laterally therefrom, said members supporting a tire on said wheel from below, the wheel contacting surfaces of the support members allowing a mutual distance less than the outer diameter of said tire, said distance being secured by mounting a locking device interlocking the outer ends of each set of support members, and finally a maneuvering device e.g. a stacker or a forklift is brought into operational engagement with fork openings in the carrier structure in order for a vehicle supported by the supporting device, to be lifted and maneuvered.

13. Method according to claim 12, wherein the support members and/or attachment points are chosen to adapt properly to a height and distance defined by a corresponding tire/wheel on a vehicle to be moved at a location.

14. Method according to claim 12, wherein a defined distance between the support members of each set is secured by a locking device in the form of any type of chain, wire or fish plate.

15. Method of lifting and maneuvering a vehicle in a garage, wherein a supporting device comprising a carrier structure is positioned under a vehicle, then for each wheel of a front or rear axle of the vehicle a set of supporting members are attached to suitable attachment points of a surface of said structure and protrudes laterally therefrom, said members supporting a tire on said wheel from below, the wheel contacting surfaces of the support members allowing a mutual distance less than the outer diameter of said tire, said distance being secured by mounting a locking device interlocking the outer ends of each set of support members, and finally a maneuvering device e.g. a stacker or a forklift is brought into operational engagement with fork openings in the carrier structure in order for a vehicle supported by the supporting device, to be lifted and maneuvered, making use of a vehicle supporting device according to claim 1.
